(19) United States
(12) Patent Application Publication
(10) Pub. No.: US 2021/0362618 A1
(43) Pub. Date: Nov. 25, 2021

(54) CHARGING MANAGEMENT DEVICE FOR VEHICLE AND METHOD THEREFOR

(71) Applicants: Hyundai Motor Company, Seoul (KR); Kia Motors Corporation, Seoul (KR)

(72) Inventor: Young Jae Park, Hwaseong (KR)

(21) Appl. No.: 17/032,580

(22) Filed: Sep. 25, 2020

(30) Foreign Application Priority Data
May 20, 2020 (KR) 10-2020-0060221

(51) Int. Cl. B60L 53/63; G06Q 10/06; G06Q 50/06; G06F 16/21; B60L 53/12; B60L 58/10; G01C 21/34; B60L 50/60; H02J 7/00; H02J 7/02

(52) U.S. Cl. CPC B60L 53/63; G06Q 10/06314; G06Q 50/06; G06F 16/21; B60L 53/12; H02J 7/0071; G01C 21/3469; B60L 50/60; H02J 7/0048; H02J 7/02; B60L 58/10

(57) ABSTRACT

A charging management device for vehicle and a method thereof are provided. The charging management device includes a user DB constructed based on a pattern where a user uses a wireless charging road. A power network state identifying device identifies a power network state of the wireless charging road and a battery state identifying device identifies a battery state of a vehicle. A controller then generates a charging schedule with regard to a user profile, the power network state of the wireless charging road, and the battery state of the vehicle and adjusts battery charging based on the generated charging schedule.

### CROSS-REFERENCE TO RELATED APPLICATION

This application claims the benefit of priority to Korean Patent Application No. 10-2020-0060221, filed on May 20, 2020, the entire contents of which are incorporated herein by reference.

### TECHNICAL FIELD

The present disclosure relates to a charging management device for vehicle and a method therefor, and more particularly, to a charging management device that maintains a charging level necessary for operation of the vehicle in a wireless charging road environment capable of charging the vehicle while driving to increase convenience of the user and a method therefor.

### BACKGROUND

An electric vehicle charges a battery thereof and is driven using the power of the charged battery. Since the driving of the electric vehicle when the battery power is insufficient causes issues, an infrastructure for receiving charging power in the situation where power is insufficient while driving should be developed. Thus, as a charging station is provided on a route of the road, the electric vehicle may charge the battery at the charging station located on the path where the electric vehicle is traveling.

Recently, as infrastructures have been constructed on the road, technologies of simultaneously proceeding with charging an electric vehicle while the electric vehicle is traveling on the road have been developed. However, various variables may occur in using power in a wireless charging environment of the electric vehicle. Particularly, power shortages are expected due to an increase in electric vehicle market. Thus, there is a need for a method for efficiently adjusting power demand in a wireless charging environment.

### SUMMARY

The present disclosure provides a charging management device for vehicle for managing such that a charging level necessary for operation of the vehicle is maintained in a wireless charging road environment capable of charging the vehicle while driving to increase convenience of the user and a method therefor.

Another aspect of the present disclosure provides a charging management device for vehicle for generating a charging schedule which incurs a minimum power charging cost with regard to a power supply situation and a power price for each time zone in a wireless charging road environment and managing battery charging to save charging costs and a method therefor. The technical problems to be solved by the inventive concept are not limited to the aforementioned problems, and any other technical problems not mentioned herein will be clearly understood from the following description by those skilled in the art to which the present disclosure pertains.

According to an aspect of the present disclosure, a charging management device for vehicle may include a user database (DB) constructed based on a pattern where a user uses a wireless charging road, a power network state identifying device configured to identify a power network state of the wireless charging road, a battery state identifying device configured to identify a battery state of a vehicle, and a controller configured to generate a charging schedule with regard to a user profile, the power network state of the wireless charging road, and the battery state of the vehicle and adjust battery charging based on the generated charging schedule.

The power network state of the wireless charging road may include information regarding a power supply state of a power network and information regarding a power price for each time zone. The controller may be configured to generate the charging schedule in an order of time zones when a power price is low, based on the information regarding the power supply state of the power network and the information regarding the power price for each time zone. The controller may be configured to generate the charging schedule except for a time zone when the power supply state is less than a reference level, based on the information regarding the power supply state of the power network and the information regarding the power price for each time zone.

The power network state management device may be configured to receive information regarding the power network state from an infrastructure located on the wireless charging road. The controller may be configured to generate the charging schedule again based on changed power network state information, when the changed power network state information is received from the infrastructure before the vehicle arrives at a destination. The controller may be configured to generate the charging schedule again based on at least one of a remaining distance to the destination, the battery state, or a location of a road section where a power supply state of a power network is greater than or equal to a reference level, when the power supply state of the power network changes to less than the reference level. The controller may be configured to request a navigation to provide line or route guidance according to the charging schedule, when the charging schedule is generated.

The battery state of the vehicle may include information regarding remaining battery capacity and information regarding a necessary amount of power needed until the vehicle arrives at a destination. The charging management device according to an exemplary embodiment of the present disclosure may further include a driving environment management device configured to obtain and manage a use pattern of the wireless charging road while the vehicle is being driven. The use pattern of the wireless charging road may include information regarding a use time zone and an average use time of the wireless charging road.

Furthermore, the charging management device according to an exemplary embodiment of the present disclosure may further include a user DB management device configured to construct and manage the user DB based on weekly data generated based on the information regarding the use time zone and the average use time of the wireless charging road for each day of the week and update the user DB using an average value of the weekly data during a certain period. The user DB management device may be configured to update the user DB based on the charging schedule, when the vehicle arrives at a destination.

According to an aspect of the present disclosure, a charging management method for vehicle may include identifying a use pattern of a wireless charging road from a user DB, identifying a power network state of the wireless charging road, identifying a battery state of a vehicle, and generating a charging schedule with regard to the use pattern of the wireless charging road, the power network state of the wireless charging road, and the battery state of the vehicle and adjust battery charging based on the generated charging schedule.

### BRIEF DESCRIPTION OF THE DRAWINGS

The above and other objects, features and advantages of the present disclosure will be more apparent from the following detailed description taken in conjunction with the accompanying drawings:

FIG. 1 is a drawing illustrating a wireless charging road environment according to an exemplary embodiment of the present disclosure;

FIG. 2 is a block diagram illustrating a configuration of a charging management device for vehicle according to an exemplary embodiment of the present disclosure;

FIG. 3 is a drawing illustrating an operation of a charging management device for vehicle according to an exemplary embodiment of the present disclosure; and

FIGS. 4, 5, and 6 are flowcharts illustrating operational flow of a charging management method for vehicle according to an exemplary embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Furthermore, control logic of the present disclosure may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, some exemplary embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the exemplary embodiment of the present disclosure, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

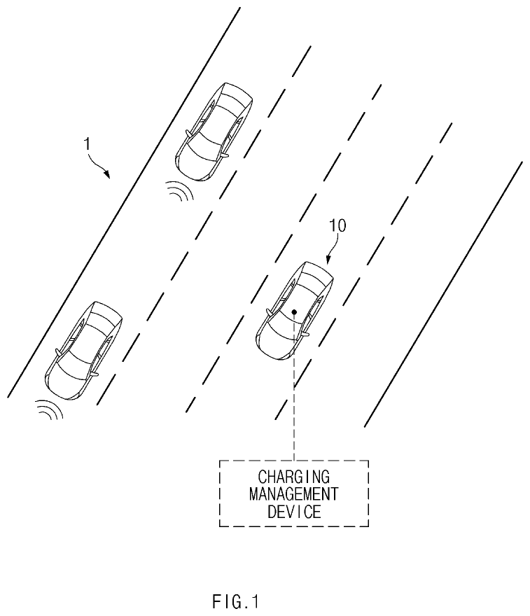

FIG. 1 is a drawing illustrating a wireless charging road environment according to an exemplary embodiment of the present disclosure. Referring to FIG. 1, a wireless charging road 1 for supplying power for wireless charging to a vehicle which is being driven may be implemented on the road on which the vehicle is being driven. In particular, the wireless charging road 1 may be provided on one of lanes of the road. As an example, the wireless charging road 1 may be provided on the outermost lane among lanes of the road. Of course, a location where the wireless charging road 1 is provided is not limited thereto and the wireless charging road may be provided in various manners according to an implementation form.

At least one infrastructure for providing state information of a power network to vehicles may be installed on the wireless charging road 1. Thus, the infrastructure may provide a target vehicle with the state information of the power network based on a request of the vehicle. Herein, the state information of the power network may include information regarding a power supply state of the power network, information regarding a power price for each time zone, and the like.

The vehicle may have a charging management device 100 configured to manage a state and charging of a battery of the vehicle while driving. Thus, the charging management device 100 may be configured to receive state information of the power network from the infrastructure on the wireless charging road 1 while driving and may be configured to generate a charging schedule with regard to the received state information of the power network. In particular, the charging management device 100 may be configured to generate the charging schedule with regard to a pattern in which a user uses the wireless charging road 1. The charging management device 100 may be configured to generate the charging schedule, which incurs a minimum cost, with regard to a power supply state of the power network and a power price for each time zone and may be configured to perform charging control of the battery of the vehicle based on the generated charging schedule.

Herein, the charging management device 100 may be configured to generate the charging schedule except for a time zone where the power supply state is less than a reference level. The charging management device 100 according to an exemplary embodiment of the present disclosure may be implemented in the vehicle. In particular, the charging management device 100 may be integrally configured with controllers in the vehicle or may be implemented as a separate device to be connected with the control units of the vehicle by a separate connection means. Herein, the charging management device 100 may be linked to an engine and a motor of the vehicle to operate and may be linked to a controller configured to operate the engine or the motor.

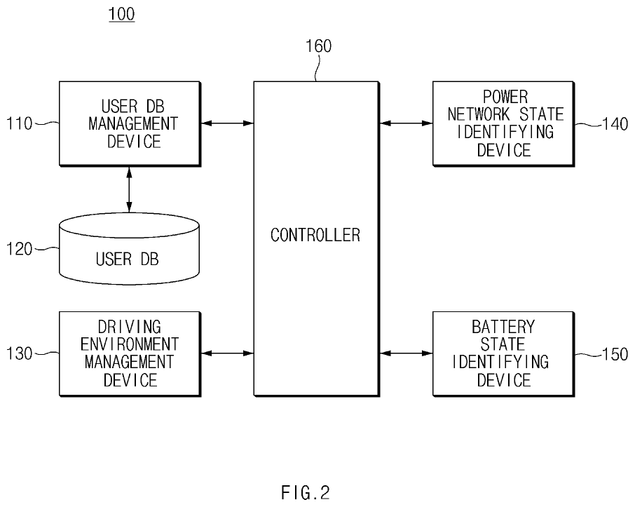

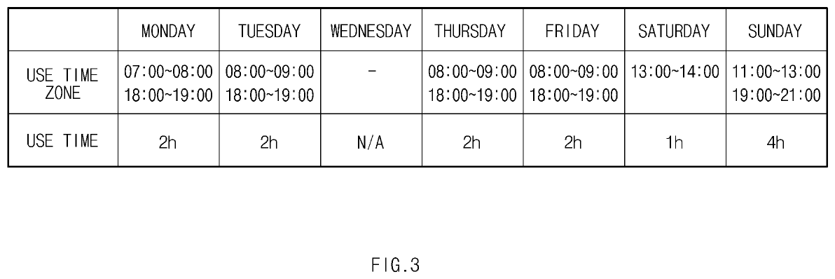

Thus, a description will be given in detail of a configuration and operation of the charging management device 100 with reference to an exemplary embodiment of FIG. 2. FIG. 2 is a block diagram illustrating a configuration of a charging management device for vehicle according to an exemplary embodiment of the present disclosure. FIG. 3 is a drawing illustrating an operation of a charging management device for vehicle according to an exemplary embodiment of the present disclosure.

Referring to FIG. 2, a charging management device 100 may include a user DB management device 110, a user DB 120, a driving environment management device 130, a power network state identifying device 140, a battery state identifying device 150, and a controller 160. The user DB management device 110 may be configured to construct and store the user DB 120 and manage a user profile stored in the user DB 120. As an example, the user DB management device 110 may be configured to construct the user DB 120 using the user profile for a use pattern of a wireless charging road 1 of FIG. 1.

Herein, the use pattern of the wireless charging road 1 may include a use time zone where a user uses the wireless charging road 1 and/or information regarding a daily average use time of the wireless charging road 1, and/or the like. Herein, the user DB 120 may be constructed based on weekly data obtained by recording the use time zone of the wireless charging road 1 and/or the information about the daily average use time of the wireless charging road 1 on a weekly basis.

A detailed exemplary embodiment of the user DB 120 will be described with reference to FIG. 3. Referring to FIG. 3, the user uses the wireless charging road 1 in the time zone of 07:00 to 08:00 and 18:00 to 19:00 on Monday and the daily average use time of the wireless charging road 1 is 2 hours.

Furthermore, the user uses the wireless charging road 1 in the time zone of 08:00 to 09:00 and 18:00 to 19:00 on Tuesday and the daily average use time of the wireless charging road 1 is 2 hours. Additionally, the user uses the wireless charging road 1 in the time zone of 08:00 to 09:00 and 18:00 to 19:00 on Thursday and the daily average use time of the wireless charging road 1 is 2 hours. Further, the user uses the wireless charging road 1 in the time zone of 08:00 to 09:00 and 18:00 to 19:00 on Friday and the daily average use time of the wireless charging road 1 is 2 hours.

In addition, the user uses the wireless charging road 1 in the time zone of 13:00 to 14:00 on Saturday and the daily average use time of the wireless charging road 1 is 1 hour. Furthermore, the user uses the wireless charging road 1 in the time zone of 11:00 to 13:00 and 19:00 to 21:00 on Sunday and the daily average use time of the wireless charging road 1 is 4 hours. Meanwhile, the user does not use the wireless charging road 1 on Wednesday.

The user DB 120 shown in FIG. 3 may be updated by data of a corresponding day of the week when the driving of the vehicle is completed and may be updated by weekly data on a weekly basis or on a monthly basis. The user DB management device 110 may be configured to update information stored in the user DB 120 using weekly data during a predetermined period. As an example, the user DB management device 110 may be configured to update information stored in the user DB 120 using weekly data recorded on a weekly basis for one month.

In particular, the user DB management device 110 may be configured to update information stored in the user DB 120 using an average value of the weekly data during the predetermined period. The user DB management device 110 may be configured to construct, store, and manage a DB for each user, when a plurality of users use the vehicle. The driving environment management device 130 may be configured to manage the use pattern of the wireless charging road 1 for the user when the vehicle is being driven.

Herein, the driving environment management device 130 may be configured to obtain and manage a day of the week when the wireless charging road 1 is used and information regarding a time zone when the wireless charging road 1 is used, while the vehicle is traveling. Furthermore, the driving environment management device 130 may be configured to obtain and manage information about an average time when the vehicle uses the wireless charging road 1 for a day. In particular, the driving environment management device 130 may be configured to deliver information regarding a use time zone of the wireless charging road 1 and a daily average use time of the wireless charging road 1 for each day of the week to the user DB management device 110.

Additionally, the driving environment management device 130 may be configured to generate weekly data based on information regarding a use time zone of the wireless charging road 1 and a daily average use time of the wireless charging road 1 for each day of the week and may be configured to deliver the weekly data the user DB management device 110. As an example, when the vehicle arrives at the destination and the driving of the vehicle is completed, the driving environment management device 130 may be configured to deliver information regarding a time zone and a use time when the road actually uses the wireless charging road 1 while driving to the user DB management device 110. Thus, the user DB management device 110 may be configured to update the user DB 120 using the information regarding the use time zone and the use time of the wireless charging road 1, which is received from the driving environment management device 130 when the driving of the vehicle is completed.

Particularly, the user DB management device 110 may be configured to update an average use time of the wireless charging road 1 for a week for each time zone using the information about the use time zone and the use time of the wireless charging road 1. As an example, assuming that a use time of a first time zone for a week is that t1=[t11, t12, t13, t14, t15, t16, t17], when t1=[1, 1, 0, 1, 1, 0, 0], an average use time of the first time zone for a weekly may be calculated with reference to Equation 1 below.

$${t}_{1} = \frac{{\sum }_{i = 1}^{7} {\tilde{t}}_{i}^{1}}{7} \qquad Equation 1$$

The power network state identifying device 140 may be configured to receive power network state information from a power network which manages a power network state of the wireless charging road 1. In particular, the power network state identifying device 140 may be configured to receive power network state information in real time from the power network. Meanwhile, the power network state identifying device 140 may be configured to request the power network to transmit power network state information and may be configured to receive the power network state information from the power network in response to the request.

When the power network state information is changed, the power network state identifying device 140 may be configured to receive the changed power network state information from the power network. Herein, the power network state information may include information regarding a power supply state of the power network, information regarding a power price for each time zone, and the like.

The charging management device 100 may separately include a communication module supporting a communication interface with the power network. Meanwhile, the charging management device 100 may be configured to transmit and receive a signal with the power network via a communication module of the vehicle, without having a separate communication module. Herein, the communication module may include a module for accessing the wireless Internet or a module for short-range communication.

A wireless Internet technology may include wireless local area network (WLAN), wireless broadband (WiBro), wireless-fidelity (Wi-Fi), world interoperability for microwave access (WiMAX), and/or the like. Furthermore, a short range communication technology may include Bluetooth, ZigBee, ultra wideband (UWB), radio frequency identification (RFID), infrared data association (IrDA), and/or the like.

When power supply information of the power network is received, the power network state identifying device 140 may be configured to identify a power supply state of the wireless charging road 1 and power cost for each time zone according to the power supply state from the received power supply information. In particular, the power network state identifying device 140 may be configured to deliver information regarding the power supply state of the wireless charging road 1 and information regarding the power cost for each time zone according to the power supply state to the controller 160.

Meanwhile, in response to determining that there is a change in power supply information, that is, power supply state and/or power cost for each time zone while driving, the power network state identifying device 140 may be configured to deliver the changed power supply information to the controller 160. The battery state identifying device 150 may be configured to identify a battery state of the vehicle while driving. Furthermore, the battery state identifying device 150 may be configured to identify a necessary amount of power needed until the vehicle arrives at the destination, based on a remaining distance to the destination.

In particular, the battery state identifying device 150 may be configured to interwork with a navigation of the vehicle to operate. In other words, the battery state identifying device 150 may be configured to request the navigation of the vehicle to provide information regarding a remaining distance to the destination. The battery state identifying device 150 may be configured to identify a necessary amount of power required until the vehicle arrives at the destination using the information regarding the remaining distance to the destination, which is identified from the navigation of the vehicle.

The battery state identifying device 150 may be configured to deliver information regarding the identified remaining capacity of the battery and the identified necessary amount of power to the controller 160. The controller 160 may be configured to generate a charging schedule when the vehicle is traveling to the destination using the information regarding the power supply state of the power network and information regarding a real-time power price according to the power supply state, which are received from the power network state identifying device 140, and information regarding the remaining capacity of the battery and information regarding the necessary amount of power, which are received from the battery state identifying device 150.

Herein, the controller 160 may call the user DB 120, may be configured to identify a charging pattern of the user, and generate a charging schedule with regard to all of the charging pattern of the user, the power supply state, real-time power price information, the remaining capacity of the battery, and the necessary amount of power. In particular, the controller 160 may be configured to generate a charging schedule which incurs a minimum charging cost. In other words, the controller 160 may be configured to generate a charging schedule in an order of time zones when the power price is low among time zones permitted to use the wireless charging road 1, which is identified from the user DB 120, such that the amount of charging is not greater than a necessary amount of power.

As an example, assuming that the current remaining capacity of the battery is x and that a necessary amount of power needed to the destination is y, a target amount of charging required to move to the destination may be indicated as z=x−y. Furthermore, assuming that a rechargeable time zone is that t=[t1, t2, . . . , tT] (where T is 24 hours), a rechargeable time zone identified on a corresponding day of the week from the user DB 120 may be indicated as t=[0, 1, 0, . . . , tT].

Furthermore, assuming that a power price for each time zone is that p=[p1, p2, . . . , pT] (where T is 24 hours), a power price for each time zone, which is identified from the power network state identifying device 140, may be indicated as p=[100, 150, 300, . . . , pT]. In particular, when a target amount of charging is less than 0, the controller 160 may be configured to calculate a minimum power charging cost by applying t and p to Equation 2 below and may be configured to generate a charging schedule which incurs the minimum power charging cost based on the minimum power charging cost.

$$P = {\sum }_{i = 1}^{T} {min}_{\overline{t}} {t}_{i} \times {p}_{i} . \qquad Equation 2$$

In Equation 2 above, P refers to the minimum power charging cost. The minimum power charging cost P may be calculated by adding power prices in time zones when the power price is low among rechargeable time zones. In Equation 2 above, the charging schedule T=[T1, T2, . . . , TT] may be generated based on a time zone applied to calculate the minimum power charging cost.

Meanwhile, the controller 160 may be configured to generate a charging schedule except for a time zone when enough power is not supplied since the power supply state of the power network is less than a reference level when generating the charging schedule. As an example, the reference level for determining the power supply state may be determined according to, but not limited to, a suppliable amount of power. When the charging schedule until the vehicle arrives at the destination is generated, the controller 160 may be configured to adjust wireless charging of the vehicle based on the generated charging schedule.

When wireless charging is required based on the charging schedule, the controller 160 may allow the vehicle to move to the wireless charging road 1 to perform wireless charging. Otherwise, when wireless charging is not required based on the charging schedule, the controller 160 may allow the vehicle to drive after departing from the wireless charging road 1. When the charging schedule is generated, the controller 160 may be configured to request the navigation to provide lane or route guidance according to the charging schedule. Thus, the navigation may guide the vehicle to move to another lane (e.g., the charging lane) or may guide the vehicle along a route, depending on the charging schedule. Herein, the navigation may be provided in the vehicle and may interwork with the charging management device 100 to operate.

When changed power supply information is received from the power network state identifying device 140 while performing wireless charging based on the charging schedule, the controller 160 may be configured to generate a charging schedule again by reflecting the changed power supply information. As an example, when the power supply state of the power network changes to less than a reference level, the controller 160 may be configured to generate the charging schedule again based on at least one of a remaining distance to a destination, a battery state, or a location of a road section where the power supply state is greater than or equal to the reference level.

At this time, the controller 160 may be configured to adjust wireless charging based on the charging schedule generated again. Particularly, the controller 160 may be configured to request the navigation to guide the vehicle along a lane or route according to the charging schedule generated again. When the vehicle arrives at the destination, the controller 160 may be configured to deliver information about the charging schedule to the user DB management device 110. In particular, the user DB management device 110 may be configured to update a user profile, that is, a use pattern of the wireless charging road 1, which is recorded in the user DB 120 based on the charging schedule.

Although not illustrated in FIG. 2, the charging management device 100 according to an exemplary embodiment of the present disclosure may further include an interface (not shown) including an input for receiving a control command from the user, an output for outputting an operation state, an operation result, and the like of the charging management device 100. Herein, the input may include a key button and may further include a soft key implemented on a display. Furthermore, the input may further include a mouse, a joystick, a jog shuttle, a stylus pen, or the like.

The output may include the display and may further include a voice output means. In particular, a touch sensor such as a touch film, a touch sheet, or a touch pad may be provided in the display, the display may operate as a touchscreen and may be implemented in a form where the input and the output are integrated with each other. The display may include at least one of a liquid crystal display (LCD), a thin film transistor-LCD (TFT-LCD), an organic light-emitting diode (OLED) display, a flexible display, a field emission display (FED), or a three-dimensional (3D) display.

The charging management device 100 for vehicle according to an exemplary embodiment of the present disclosure, which performs the above-mentioned operations, may be implemented in the form of an independent hardware device and may be driven in the form of being included in another hardware device, such as a microprocessor, as at least one processor. A description will be given in detail of operational flow of the charging management device according to an exemplary embodiment of the present disclosure, which has the above-mentioned configuration.

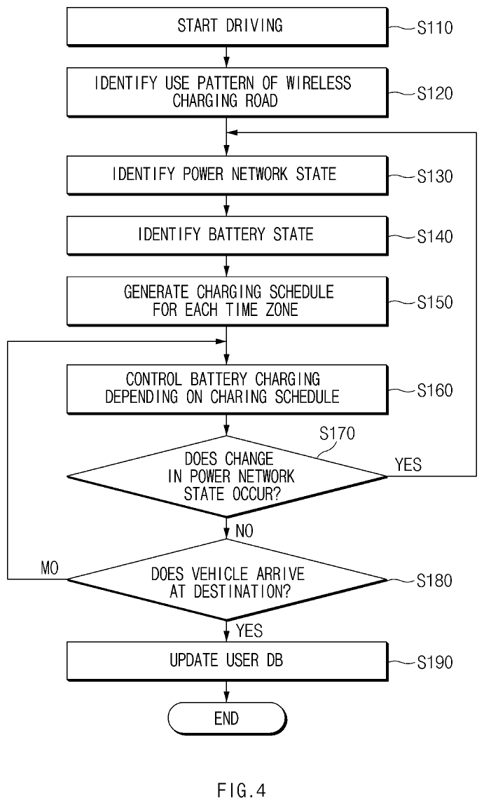

FIGS. 4 to 6 are flowcharts illustrating operational flow of a charging control method for vehicle according to an exemplary embodiment of the present disclosure. Referring to FIG. 4, when the vehicle starts to travel in S110, in S120, a charging management device 100 of FIG. 2 may be configured to call or access a user DB 120 constructed for a corresponding user and may be configured to identify a user profile. Herein, the user profile may include a use pattern of a wireless charging road 1 of FIG. 1, for example, information such as a use time zone and an average use time.

Furthermore, in S130, the charging management device 100 may be configured to identify a power network state, that is, a power supply state and information regarding a power price for each time zone, from a power network. Furthermore, in S140, the charging management device 100 may be configured to identify a battery state of the vehicle. In S140, the charging management device 100 may be configured to identify the remaining capacity of the battery of the vehicle, a necessary amount of power to a destination, and the like.

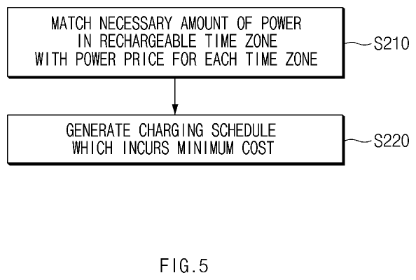

In S150, the charging management device 100 may be configured to match information identified in S120 to S140, that is, the use pattern of the wireless charging road 1, the power network state, and the battery state to generate a charging schedule. A description will be given of detailed operation flow of S150 with reference to FIG. 5.

Referring to FIG. 5, in S210, the charging management device 100 may be configured to match the use time zone and the use time of the wireless charging road 1, the necessary amount of power, and the power price for each time zone, which are identified in S120 to S140, for each time zone. In S220, the charging management device 100 may be configured to generate a charging schedule which incurs a minimum cost in an order of time zones when the power price is low among the results matched in S210.

In this process, the charging management device 100 may be configured to generate the charging schedule except for a time zone when the power supply state is less than a reference level. In S160, the charging management device 100 may be configured to adjust battery charging based on the charging schedule generated in S150 when the vehicle arrives at a destination. Meanwhile, when a change in power network state occurs before the vehicle arrives at the destination in S170, the charging management device 100 may be configured to perform S130 to S160 again to generate a charging schedule again depending on the changed power network state and adjust battery charging based on the charging schedule generated again.

Herein, the charging management device 100 may be configured to generate the charging schedule, where a power price of the wireless charging road 1 is changed or where a power supply state of the power network is changed, again. As an example, when the power supply state of the power network changes to less than a reference level, the charging management device 100 may be configured to generate the charging schedule again based on at least one of a remaining distance to a destination, a battery state, or a location of a road section where the power supply state is greater than or equal to the reference level.

At this time, the charging management device 100 may be configured to request the linked navigation to guide the vehicle to move a line or guide the vehicle along a route depending on the changed charging schedule. When the vehicle arrives at the destination in S180, in S190, the charging management device 100 may be configured to update a user DB 120 based on information regarding the use of the wireless charging road 1.

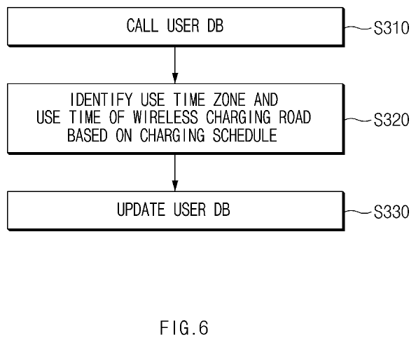

A description will be given of detailed operation flow of S190 with reference to FIG. 6. Referring to FIG. 6, in S310, the charging management device 100 may be configured to access or call the user DB 120. In S320, the charging management device 100 may be configured to identify a use time zone and a use time of the wireless charging road 1 based on the changing schedule generated while driving. In S330, the charging management device 100 may be configured to update data recorded in the user DB 120 based on the information identified in S320.

According to an exemplary embodiment of the present disclosure, the charging management device may be configured to manage such that a charging level necessary for operation of the vehicle is maintained in a wireless charging road environment capable of charging the vehicle while driving, thus increasing convenience of the user. According to an exemplary embodiment of the present disclosure, the charging management device may be configured to generate a charging schedule which incurs a minimum power charging cost with regard to a power supply situation and a power price for each time zone in a wireless charging road environment, thus saving charging costs.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, the exemplary embodiments of the present disclosure are provided to explain the spirit and scope of the present disclosure, but not to limit them, so that the spirit and scope of the present disclosure is not limited by the exemplary embodiments. The scope of the present disclosure should be construed on the basis of the accompanying claims, and all the technical ideas within the scope equivalent to the claims should be included in the scope of the present disclosure.

What is claimed is:

1. A charging management device for a vehicle, comprising:
a user database (DB) constructed based on a pattern where a user uses a wireless charging road;
a power network state identifying device configured to identify a power network state of the wireless charging road;
a battery state identifying device configured to identify a battery state of the vehicle; and
a controller configured to generate a charging schedule with regard to a user profile, the power network state of the wireless charging road, and the battery state of the vehicle and adjust battery charging based on a generated charging schedule.

2. The charging management device of claim 1, wherein the power network state of the wireless charging road includes information regarding a power supply state of a power network and information regarding a power price for each time zone.

3. The charging management device of claim 2, wherein the controller is configured to generate the charging schedule in an order of time zones when a power price is low, based on the information regarding the power supply state of the power network and the information regarding the power price for each time zone.

4. The charging management device of claim 2, wherein the controller is configured to generate the charging schedule except for a time zone when the power supply state is less than a reference level, based on the information regarding the power supply state of the power network and the information regarding the power price for each time zone.

5. The charging management device of claim 1, wherein the power network state management device is configured to receive information regarding the power network state from an infrastructure located on the wireless charging road.

6. The charging management device of claim 5, wherein the controller is configured to generate the charging schedule again based on changed power network state information, in response to receiving the changed power network state information from the infrastructure before the vehicle arrives at a destination.

7. The charging management device of claim 6, wherein the controller is configured to generate the charging schedule again based on at least one of a remaining distance to the destination, the battery state, or a location of a road section where a power supply state of a power network is greater than or equal to a reference level, in response to determining that the power supply state of the power network changes to less than the reference level.

8. The charging management device of claim 1, wherein the controller is configured to request a navigation to provide line or route guidance according to the charging schedule, when the charging schedule is generated.

9. The charging management device of claim 1, wherein the battery state of the vehicle includes information regarding a remaining battery capacity and information regarding a necessary amount of power needed until the vehicle arrives at a destination.

10. The charging management device of claim 1, further comprising:
a driving environment management device configured to obtain and manage a use pattern of the wireless charging road while the vehicle is being driven.

11. The charging management device of claim 10, wherein the use pattern of the wireless charging road includes information regarding a use time zone and an average use time of the wireless charging road.

12. The charging management device of claim 11, further comprising:
a user DB management device configured to construct and manage the user DB based on weekly data generated based on the information regarding the use time zone and the average use time of the wireless charging road for each day of the week and update the user DB using an average value of the weekly data during a certain period.

13. The charging management device of claim 12, wherein the user DB management device is configured to update the user DB based on the charging schedule, when the vehicle arrives at a destination.

14. A charging management method for a vehicle, comprising:
identifying, by a controller, a use pattern of a wireless charging road from a user database (DB);
identifying, by the controller, a power network state of the wireless charging road;
identifying, by the controller, a battery state of the vehicle; and
generating, by the controller, a charging schedule with regard to the use pattern of the wireless charging road, the power network state of the wireless charging road, and the battery state of the vehicle and adjusting battery charging based on a generated charging schedule.

15. The charging management method of claim 14, wherein the power network state of the wireless charging road includes information regarding a power supply state of a power network and information regarding a power price for each time zone.

16. The charging management method of claim 15, wherein the adjusting of the battery charging includes:
generating, by the controller, the charging schedule in an order of time zones when the power price is low, based on the information regarding the power supply state of the power network and the information regarding the power price for each time zone.

17. The charging management method of claim 15, wherein the adjusting of the battery charging includes:
generating, by the controller, the charging schedule except for a time zone when the power supply state is less than a reference level, based on the information regarding the power supply state of the power network and the information regarding the power price for each time zone.

18. The charging management method of claim 14, wherein the adjusting of the battery charging further includes:
generating, by the controller, the charging schedule again based on changed power network state information, in response to receiving the changed power network state information from an infrastructure located on the wireless charging road before the vehicle arrives at a destination.

19. The charging management method of claim 18, wherein the generating of the charging schedule again includes:
generating, by the controller, the charging schedule again based on at least one of a remaining distance to the destination, the battery state, or a location of a road section where a power supply state of a power network is greater than or equal to a reference level, in response to determining that the power supply state of the power network changes to less than the reference level.

20. The charging management method of claim 14, further comprising:
requesting, by the controller, a navigation to provide line or route guidance according to the charging schedule, when the charging schedule is generated.

21. The charging management method of claim 14, wherein the battery state of the vehicle includes information regarding battery remaining capacity and information regarding a necessary amount of power needed until the vehicle arrives at a destination.

22. The charging management method of claim 14, further comprising:
obtaining and managing, by the controller, information regarding a use time zone and an average use time of the wireless charging road while the vehicle is being driven:
generating, by the controller, weekly data for a use pattern of the wireless charging road for each day of the week;
constructing, by the controller, the user DB based on the weekly data; and
updating, by the controller, the user DB using an average value of the weekly data during a certain period.

23. The charging management method of claim 14, further comprising:
updating, by the controller, the user DB based on the charging schedule, when the vehicle arrives at a destination.
